(19) United States
(12) Patent Application Publication
(10) Pub. No.: US 2018/0190043 A1
(43) Pub. Date: Jul. 5, 2018

(54) Mileage Tracking Provisioning

(71) Applicant: Bosch Automotive Service Solutions Inc., Warren, MI (US)

(72) Inventor: Maria John Paul Dominic, Owatonna, MN (US)

(21) Appl. No.: 15/393,764

(22) Filed: Dec. 29, 2016

(51) Int. Cl. G07C 5/08; G07C 5/00; G01C 22/00

(52) U.S. Cl. CPC G07C 5/085; G07C 5/008; G07C 2205/02; G01C 22/00; G07C 5/0825

(57) ABSTRACT

A system and process are provided that allows a vehicle owner, such as a fleet vehicle company to remotely monitor mileage of its vehicles. This allows the fleet owner to provide timely preventative maintenance on the vehicle based on the vehicle's mileage. Additionally, the process uses the vehicles OBD II system to verify the mileage being reported by the driver in order to prevent fraud related to reporting incorrect mileage.

### FIELD OF THE DISCLOSURE

The present disclosure relates generally to a diagnostic tool, such as a scan tool. More particularly, the present disclosure relates to a diagnostic tool that is able to determine mileage of a vehicle such as a fleet vehicle.

### BACKGROUND

Vehicle fleet owners such as car rental companies or trucking companies need to keep accurate track of their vehicle's mileage for proper maintenance and billing purposes. These fleet owners typically rely on the driver to correctly record the miles such as at the time the vehicle is rented and when the vehicle is returned to the rental facility. However, the mileage is often not properly recorded or are estimated and entered. This leads to issues like missed preventive maintenance, inability to accurately invoice clients for mileage and travel time, undetected fuel theft or unauthorized detours by the driver, incorrect tax depreciation of the vehicles, and expense report padding.

Diagnostic Trouble Codes are often used by vehicle manufacturers to indicate an issue with components such as the engine of the vehicle. However, currently there no mileage information that may be obtained from using generic OBD II and thus making it difficult to determine accurate mileage of vehicles. Often fleet technicians can only determine mileage when the maintenance light is illuminated such as at 30,000 miles or 45,000 miles and the like.

There is a need to be able to retrieve mileage from a vehicle at any given time for accurate reporting of miles for various fleet reports. This allows for more accurate preventive maintenance of the vehicles to be scheduled and thus preventing costly maintenance down the road.

### SUMMARY

The foregoing needs are met, to a great extent, by the present disclosure, wherein in one aspect of an apparatus is provided in some embodiments to include a diagnostic tool capable of determining accurate mileage of a vehicle upon request by a manager or owner.

In one embodiment, a non-transitory machine-readable storage medium comprising machine-readable instructions for causing a processor of a computing device to execute the method of receiving, by a processor of the computing device, a response from an electronic control unit (ECU) of a vehicle under test regarding available vehicle diagnostic information stored in the ECU, receiving, by the processor of the computing device, and storing on a memory of the computing device, a first speed of the vehicle at a predetermined time interval, receiving, by the processor of the computing device, and storing on the memory of the computing device, a first vehicle's driven mileage distance since a diagnostic trouble code (DTC) was cleared, receiving, by the processor of the computing device, a mileage on an odometer of the vehicle, determining, with the processor of the computing device, a difference mileage between the received odometer mileage and the first vehicle's driven mileage distance since the DTC was cleared, determining by the processor of the computing device a final mileage of the vehicle by adding the first vehicle's driven distance mileage since the DTC was cleared and the received odometer mileage, and determining by the processor of the computing device that there is an error if the difference between the determined final mileage and the received odometer mileage is more than 5 KM.

In another embodiment, a vehicle diagnostic tool with mileage retrieval includes a processor configured to execute computing instructions, a connector interface configured to connect with a connector in a vehicle and retrieve vehicle diagnostic data from the vehicle, wherein vehicle diagnostic data include a first speed of a vehicle at a predetermined time interval and a first vehicle's driven mileage distance since a diagnostic trouble code (DTC) was cleared, a display in communication with the processor configured to display vehicle diagnostic data, a wireless communication interface in communication with the processor and configured to communicate with a remote device having a database, and a memory in communication with the processor, the memory containing instructions, that when executed by the processor causes the processor to receive a response from an electronic control unit (ECU) of a vehicle under test regarding available vehicle diagnostic information stored in the ECU, receive and store on the memory of the vehicle diagnostic tool, the first speed of the vehicle at a predetermined time interval, receive and store on the memory of the vehicle diagnostic tool, the first vehicle's driven mileage distance since a diagnostic trouble code (DTC) was cleared, receive a mileage on an odometer of the vehicle entered by a user, determine, a difference mileage between the received odometer mileage and the first vehicle's driven mileage distance since the DTC was cleared, determine a final mileage of the vehicle by adding the first vehicle's driven distance mileage since the DTC was cleared and the received odometer mileage, and determine that there is an error if the difference between the determined final mileage and the received odometer mileage is more than 5 KM.

In still another embodiment, a vehicle diagnostic tool is provided and includes means for processing configured to execute computing instructions, means for interfacing configured to connect with a connector in a vehicle and retrieve vehicle diagnostic data from the vehicle, wherein vehicle diagnostic data include a first speed of a vehicle at a predetermined time interval and a first vehicle's driven mileage distance since a diagnostic trouble code (DTC) was cleared, means for displaying in communication with the means for processing configured to display vehicle diagnostic data, means for wireless communicating in communication with the means for processing and configured to communicate with a remote device having a database, and means for storing in communication with the means for processing, the means for storing containing instructions, that when executed by the means for processing causes the means for processing to receive a response from an electronic control unit (ECU) of a vehicle under test regarding available vehicle diagnostic information stored in the ECU, receive and store on the means for storing of the vehicle diagnostic tool, the first speed of the vehicle at a predetermined time interval, receive and store on the means for storing of the vehicle diagnostic tool, the first vehicle's driven mileage distance since a diagnostic trouble code (DTC) was cleared, receive a mileage on an odometer of the vehicle entered by a user, determine, a difference mileage between the received odometer mileage and the first vehicle's driven mileage distance since the DTC was cleared, determine a final mileage of the vehicle by adding the first vehicle's driven distance mileage since the DTC was cleared and the received odometer mileage, and determine that there is no error if the difference between the determined final mileage and the received odometer mileage is less than 5 KM.

There has thus been outlined, rather broadly, certain embodiments of the disclosure in order that the detailed description thereof herein may be better understood, and in order for the present contribution to the art may be better appreciated. There are, of course, additional embodiments of the disclosure that will be described below and which will form the subject matter of the claims appended hereto.

In this respect, before explaining at least one embodiment of the disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

### BRIEF DESCRIPTION OF THE DRAWINGS

FIG. 1 depicts a front view of a diagnostic tool according to an exemplary embodiment of the present disclosure.

FIG. 2 is a block diagram of the components of the diagnostic tool of FIG. 1 according to an embodiment of the disclosure.

FIG. 3 illustrates a diagnostic tool and a smart phone according to an embodiment of the disclosure.

FIG. 4 illustrates exemplary components of the diagnostic tool of FIG. 3 according to an embodiment of the disclosure.

FIGS. 5A, 5B and 5C illustrate a method of determining mileage of a vehicle according to an embodiment of the disclosure.

FIG. 6 illustrates the diagnostic tool or smartphone communicating with one or more remote computing devices according to an embodiment of the disclosure.

### DETAILED DESCRIPTION

The disclosure will now be described with reference to the drawing figures, in which like reference numerals refer to like parts throughout. An embodiment in accordance with the present disclosure provides a computing device such as vehicle diagnostic tool, a desktop computer, notebook, a tablet, or smart watch/wearable or a smart phone that can query a vehicle for its mileage information and transmitting the information to the fleet manager or system.

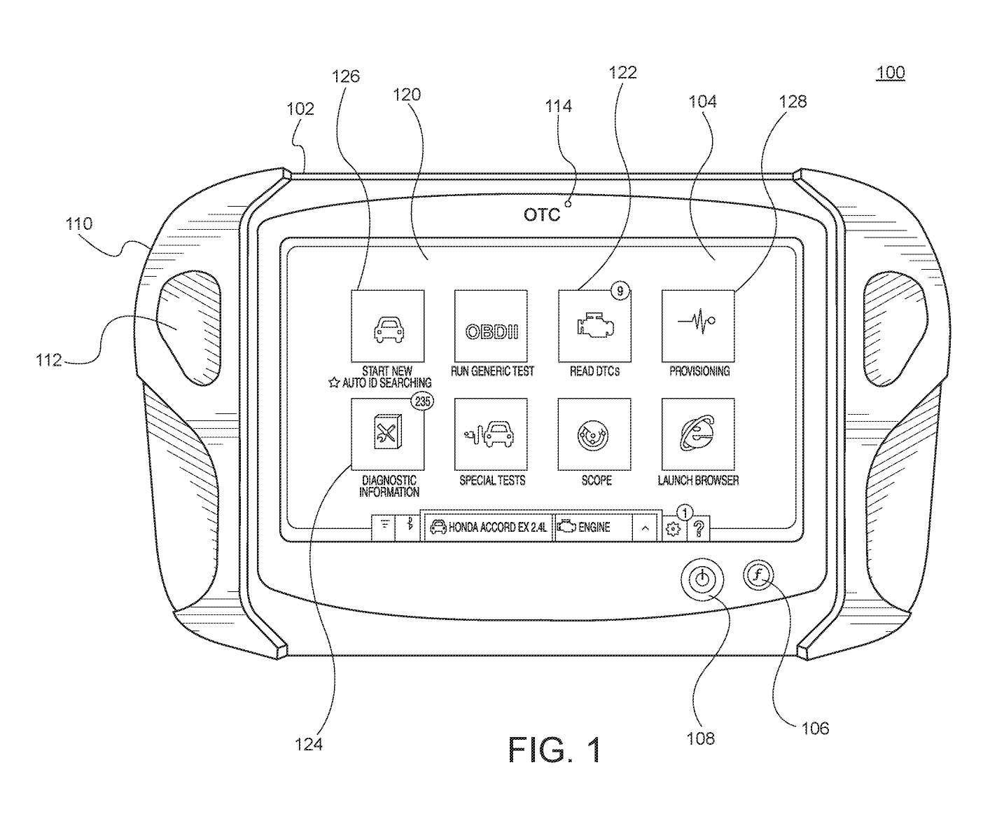

FIG. 1 illustrates a front view of a diagnostic tool 100 according to an embodiment of the disclosure. An example of the diagnostic tool is the Genisys® Touch or Encore from Bosch Automotive Service Solutions, Inc. (Owatonna, Minn.). The diagnostic tool 100 may include a housing 102, a display 104, a function button or a user interface 106, a power button 108, gripping portions 110 having a finger (thumb) receiving portion 112, a camera 114 and graphical user interface 120 having various icons for activation such as READ DTCs 122, DIAGNOSTIC INFORMATION 124, START NEW AUTO ID SEARCHING 126, and PROVISIONING AND MONITORING 128. The power button 108 can also be used to put the diagnostic tool 100 into a standby mode in order to save battery power when not in use.

The gripping portions 110 may be made of a polymer including hydrogels for easy gripping. The finger-receiving portion 112 may be configured to receive a finger, such as a thumb of the user, to assist in better gripping of the diagnostic tool 100. The function button or user interface 106 may be configured for any function desired by the user including enter, back, forward, left, right, up, down, transmit, receive, return, start over, and the like. The function button can also include multiple functions of any combination of functions, such as enter and then back, etc. The user interface 106 may also include a keyboard having numbers and letters and/or be alphanumeric and the like.

The display 104 can be any type of display including a touch screen display, LCD, LED, VGA, OLED, SVGA, and other types of displays. The display 104 may be a colored, non-colored (e.g. gray scale), or a combination of both. The display 104 can display information such as the make, model, year of vehicle that the diagnostic tool 100 can diagnose, the various diagnostic tests the diagnostic tool can run, diagnostic data the diagnostic tool has received, the baseline data of the various components in a vehicle, part images, parts information, mileage and information from remote servers (internet, database information, etc.). Additionally, the display can show videos for the user to view, and the accompanying audio can be heard via the built-in speakers (not shown). The speakers can be a single speaker or multiple speakers for stereo sound. A microphone (not shown) may be included and allows the technician to record information such as the noise being made by the vehicle for later analysis or for comparison with stored data. Further, the technician can also record comments or notes during the testing for later retrieval and analysis.

In one embodiment, the display allows the user to input selection through the touch screen for interactive navigation and selection, wherein the technician can select a menu item or icons (further discussed below) by touching the selection on the graphical user interface (GUI) 120. Additionally, the display 104, when tapped or touched, can also be used to wake up the diagnostic tool 100 if it is in a sleep mode.

The GUI 120 may include various icons, information banner, modules, interface elements, and the like. The icons or modules may be activated by touching with a finger or a stylus and the like on the display 104 or through the user interface 106. The display 104 can be touch sensitive and is able to interpret finger contacts, finger tap gestures, finger swipe gestures, stylus movements, any combination thereof, and the like. It should be understood that, in some embodiments, one or more of the finger inputs are replaced with input from another input device (e.g., a mouse based input or stylus input). For example, a swipe gesture may be replaced with a mouse click (e.g., instead of a contact) followed by movement of the cursor along the path of the swipe (e.g., instead of movement of the contact). A further embodiment, a tap gesture may be replaced with a mouse click while the cursor is located over the location of the tap gesture (e.g., instead of detection of the contact followed by ceasing to detect the contact). Similarly, when multiple user inputs are simultaneously detected, it should be understood that multiple computer mice may be used simultaneously, or a mouse and finger contacts may be used simultaneously.

The camera 114 may be positioned to face the user so that the user may conduct a video chat with another person at a remote location. The camera may also be positioned on any surface of the diagnostic tool 100 including on the opposite side of display 104 so that images of parts of an engine or any components desired by the user can be taken.

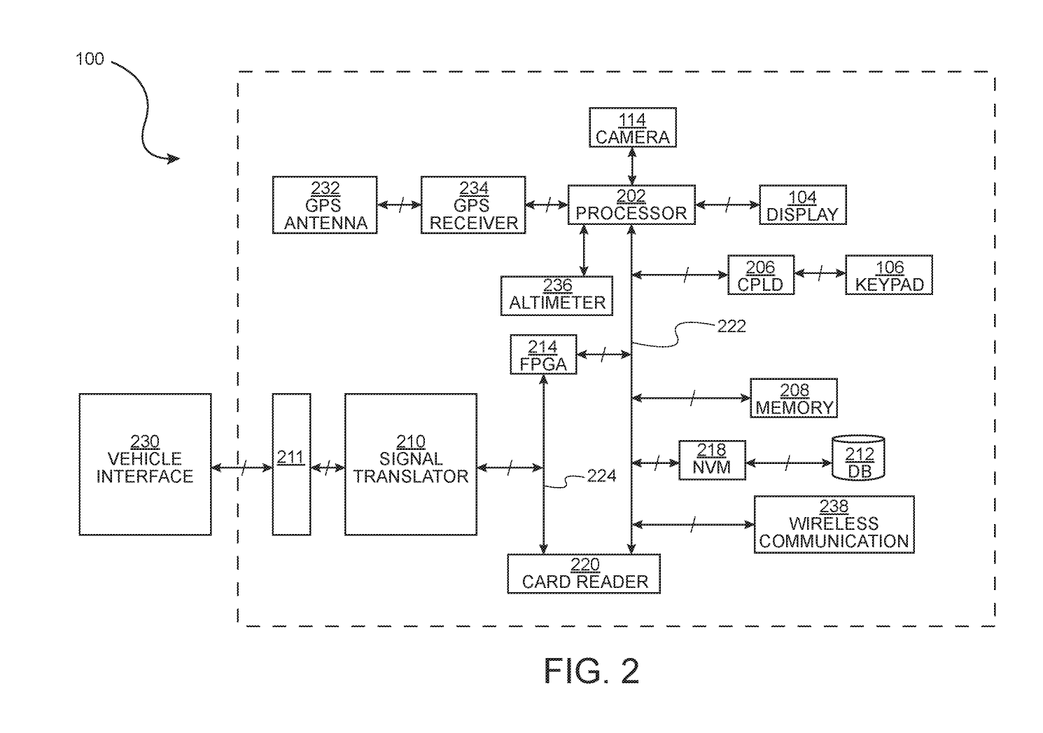

FIG. 2 is a block diagram of the components of the diagnostic tool 100 of FIG. 1 according to an embodiment of the disclosure. In FIG. 2, the diagnostic tool 100 according to an embodiment of the disclosure may include a camera 114, a diagnostic processor 202, a field programmable gate array (FPGA) 214, a first system bus 224, the display 104, a complex programmable logic device (CPLD) 206, the input device 106 or function button, a memory 208, an internal non-volatile memory (NVM) 218 is a special diagnostic memory having a database 212 with software program and vehicle diagnostic information such as a vehicle diagnostic software that can determine mileage of a vehicle under test, a card reader 220, a second system bus 222, a connector interface 211, a selectable signal translator 210, a GPS antenna 232, a GPS receiver 234, an optional altimeter 236, and a wireless communication circuit 238.

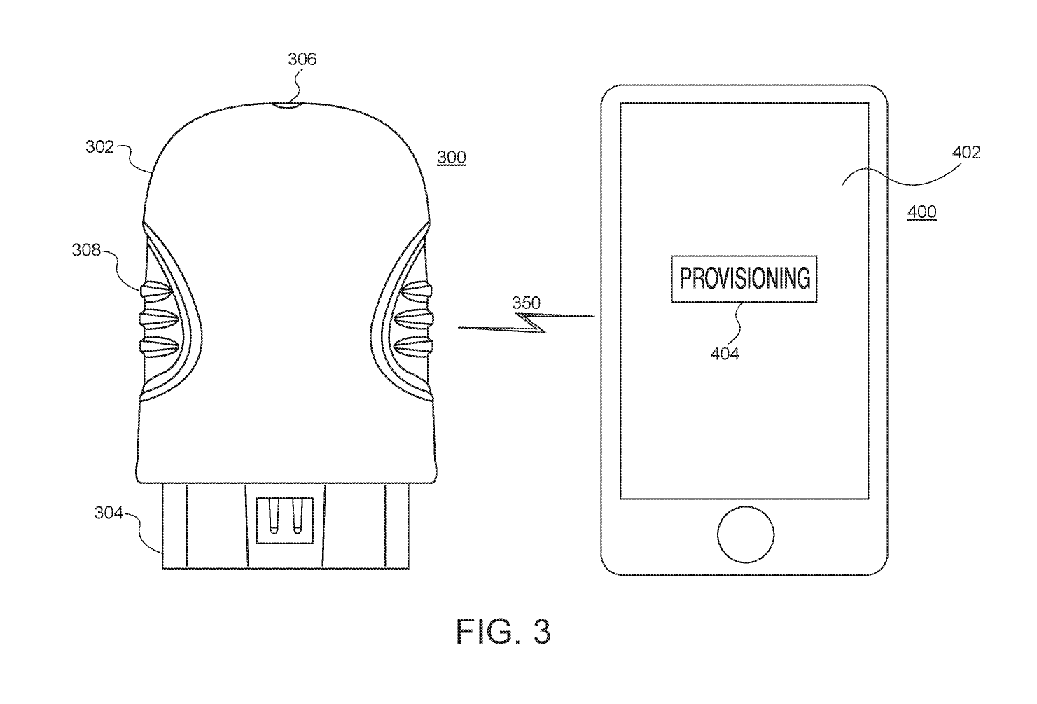

In one embodiment, the wireless communication circuit 238 can be configured to communicate wirelessly with a vehicle communication interface (not shown) that is coupled to the vehicle's interface (not shown) or another remote device such as a fleet manager server/computing system. The vehicle communication interface sends signals and vehicle data received from the various electronic control units (ECUs) or engine systems in the vehicle to the wireless communication circuit 238. Wireless communication circuit 238 communicates with the processor 202 via the second system bus 222. The wireless communication circuit 238 can be configured to communicate via RF (radio frequency), satellites, cellular phones (analog or digital), Bluetooth®, Wi-Fi, Infrared, ZigBee, Local Area Networks (LAN), WLAN (Wireless Local Area Network), NFC (near field communication), other wireless communication configurations and standards, or a combination thereof. The wireless communication circuit 238 allows the diagnostic tool 100 to communicate with other devices wirelessly such as with a remote computing device (FIG. 3) having remote databases. The wireless communication circuit 238 includes an antenna or transceiver built therein (not shown) and being housed within the housing 102 or can be externally located on the housing 102. Further, the wireless communication circuit 238 is also configured to communicate via a wired connection such as Universal Serial Bus (USB), Firewire, parallel, serial, Ethernet and the like.

Signal translator 210 conditions signals received from an ECU unit through the wireless communication circuit 238 or through the connector interface 211 to a conditioned signal compatible with diagnostic tool 100. Signal translator 210 can communicate with, for example, the following communication protocols: J1850 (VPM and PWM), ISO 9141-2 signal, communication collision detection (CCD) (e.g., Chrysler collision detection), data communication links (DCL), serial communication interface (SCI), Controller Area Network (CAN), Keyword 2000 (ISO 14230-4), OBD II or other communication protocols that are implemented in a vehicle.

The circuitry to translate and send in a particular communication protocol can be selected by FPGA 214 (e.g., by tri-stating unused transceivers). Signal translator 210 may be also coupled to FPGA 214 and the card reader 220 via the first system bus 224. FPGA 214 transmits to and receives signals (i.e., messages) from the ECU unit through signal translator 210 and the wireless communication circuit 238.

The FPGA 214 may be coupled to the processor 202 through various address, data and control lines by the second system bus 222. FPGA 214 is also coupled to the card reader 220 through the first system bus 224. The processor 202 may also be coupled to the display 104 in order to output the desired information to the user. The processor 202 communicates with the CPLD 206 through the second system bus 222. Additionally, the processor 202 may be programmed to receive input from the user through the input device 106 via the CPLD 206 or via the touchscreen display 104. The CPLD 206 may provide logic for decoding various inputs from the user of the diagnostic tool 100 and also provides glue-logic for various other interfacing tasks.

The processor 202 is a special processor or a diagnostic processor that configured to retrieve diagnostic information from a vehicle's ECU. The processor can be adapted to retrieve and process OBD II information from the vehicle's OBD II in order to retrieve OBD II diagnostic data and display it in a graphical format for the user.

Memory 208 and internal non-volatile memory 218 may be coupled to the second system bus 222, which allows for communication with the processor 202 and FPGA 214. Memory 208 can include an application dependent amount of dynamic random access memory (DRAM), a hard drive, and/or read only memory (ROM). Software to run the diagnostic tool 100 including the GUI can be stored in the memory 208 or 218, including any other database. The diagnostic software includes instructions so that the processor 202 can retrieve mode 6 data from the vehicle's OBD II continuously and dynamically and display it in a graphical format such as a GUI on a display of the diagnostic tool. The database 212 can include diagnostic information and other information related to vehicles.

Internal non-volatile memory 218 can be an electrically erasable programmable read-only memory (EEPROM), flash ROM, or other similar memory. Internal non-volatile memory 218 can provide, for example, storage for boot code, self-diagnostics, various drivers, and space for FPGA images, if desired. Additionally, the internal non-volatile memory 218 may also include software such as a graphics module for rendering and displaying graphics (e.g. icons or modules) on the touchscreen display 104. If less than all of the modules are implemented in FPGA 214, memory 218 can contain downloadable images so that FPGA 214 can be reconfigured for a different group of communication protocols.

A GPS antenna 232 and GPS receiver 234 can be included and may be mounted in or on the housing 102 or any combination thereof. The GPS antenna 232 electronically couples to the GPS receiver 234 and allows the GPS receiver to communicate (detects and decodes signals) with various satellites that orbit the Earth. In one embodiment, the GPS antenna 232 and GPS receiver 234 are one device instead of two. The GPS receiver 234 and GPS antenna 232 may electronically couple to the processor 202, which may be coupled to memory 208, 218 or a memory card in the card reader 220. The memories can be used to store cartographic data, such as electronic maps. The diagnostic tool can include all the maps for the U.S. (or country of use), North America, or can have the region or state where the diagnostic tool is located. In alternative embodiments, the diagnostic tool can have all the maps of the world or any portion of the world desired by the user. This allows the diagnostic tool to be a GPS device so that a driver can drive from one location to another. The maps may be overlay or may incorporate traffic, local events, and location of other GPS devices (smart phones), and other information that can be useful to the technician. By being able to locate other diagnostic tools with GPS, then the technicians may be able to use the diagnostic tools to locate each other in order to conduct a meeting or have a social event.

The GPS receiver communicates with and “locks on” to a certain number of satellites in order to have a “fix” on its global location. Once the location is fixed, the GPS receiver, with the help of the processor, can determine the exact location including longitude, latitude, altitude, velocity of movement, and other navigational data of the diagnostic tool 100.

Should the GPS receiver be unable to lock onto the minimum number of satellites to determine the altitude or unable to determine the altitude for any reason, the altimeter 236 can be used to determine the altitude of the diagnostic tool 100. The altimeter 236 is electronically coupled to the processor 202 and can provide the altitude or elevation of the diagnostic tool 100. The altimeter 236 can be coupled to a barometric pressure sensor (not shown) in order to calibrate the elevation measurements determined by the altimeter. The sensor can be positioned interior or exterior to the housing 102 of the diagnostic tool 100. Minor atmospheric pressure changes can affect the accuracy of the altimeter 236, thus, diagnostic tool can correct for these changes by using the sensor in conjunction with the altimeter 236 along with a correction factor known in the art.

In an alternative embodiment, a vehicle communication interface 230 of the vehicle under test is in communication with the diagnostic tool 100 through connector interface 211 via an external cable (not shown). Selectable signal translator communicates with the vehicle communication interface 230 through the connector interface 211.

In another alternative embodiment, FIG. 3 illustrates a diagnostic tool 300 and a smart phone 400 according to an embodiment of the disclosure. An example of the diagnostic tool 300 is the U-Scan™ from Bosch Automotive Service Solutions, Inc. (Warren, Mich.) in the form of a vehicle communication interface. The diagnostic tool 300 may include a housing 302, a connector 304, and indicator 306. The housing may be made of any material such as a polymer including thermoplastic. The housing 302 also includes gripping portions 308 made of a polymer including hydrogels for easy gripping by a user such as technician. The gripping portions 308 can be protrusions or ridges extending from the housing 102.

The connector 304 is configured to mate with a data link connector on a vehicle. The data link connector (DLC) is a communication port or bus for various electronic control units on a vehicle. The connector 304 can also mate with a cable (not shown) that in turn mates with the DLC. The connector 304 can be configured to mate with any communication port that provides vehicle data such as vehicle diagnostic data.

The housing also includes the indicator 306 on an outside surface of the housing 302. The indicator can be for example, LED, MED, lights, and other types of indicators. The indicator 306 provides status information about the diagnostic tool 300 such as powered, transmitting, receiving, no connection, other malfunction, and the like. The indicator 306 can be on any surface of the housing 102 so long as it is visible to the technician or user. The diagnostic tool 300 may alternatively have a display on the housing 302 similar to display 104 (FIG. 1) of the diagnostic tool 100. The display can be any type of display including a touch screen display, LCD, LED, VGA, OLED, SVGA and other types of displays. The display may be a colored, non-colored (e.g. gray scale) or a combination of both. The display can display information such as the make, model, year of vehicles that the diagnostic tool can diagnose, the various diagnostic tests the diagnostic tool can run, diagnostic data the diagnostic tool has received, the baseline data of the various components in a vehicle, part images, parts information, mileage, and information from remote servers (internet, database information, etc.). Additionally, the display can show videos for the user to view and the accompanying audio can be heard via the built-in speakers (not shown).

The diagnostic tool 300 can communicate with a smart phone 400 via a wireless 350 or wired (not shown) connection. By communicating wirelessly, the technician can be remote from the vehicle to which the diagnostic tool 300 is attached, thereby, the technician can potentially diagnose more than one vehicle a time. The smart phone 400 can be connected to more than one diagnostic tool 300 and is also configured to communicate with diagnostic tool 100 or any other diagnostic tool.

The smart phone 400 can be any type of smart phone such as ones from HTC™, Samsung™, Motorola™, Nokia™, LeEco™ BlackBerry™, and Apple™. The smart phone 400 can also run various operate system including IOS, Android, Linux, BlackBerry 10, and Microsoft™ Windows 10 and the like. The smart phone 400 may include a display 402 that is a touch screen in order to receive various inputs from the technician and the display can also display any information to the technician. Display 402 also includes an icon such as the provisioning and monitoring icon 404 (discussed below). The smartphone 400 may include all the components noted in FIG. 2 for the diagnostic tool 100 in order to communicate with the diagnostic tool 100 and 300 including a processor, camera, GPS, FPGA, memory including non-volatile memory, database, wireless communication circuit including cellular, Bluetooth, NFC, satellite, etc., signal translator, user interface in the form of physical or virtual keys (display touch screen) and the like and thus their functionalities will not be repeated but can be referred to the description of the diagnostic tool 100. In an alternative embodiment, the smartphone 400 may operate independent of the diagnostic tool 300 by having its own interface (not shown) such as a DLC cable, which has its one end connected to the interface of the phone and the cable's other connected to the DLC of the vehicle. Thus, creating a direct connection from the smartphone 400 to the vehicle. In still another embodiment, the smartphone 400 may be a smartwatch or other wearable devices or a computing device that have similar components as described for diagnostic tool 100 and smartphone 400.

In other embodiments, the diagnostic tool 300 can communicate with other remote computing devices such as a personal computer (PC), a UNIX workstation, a server, a mainframe computer, smartwatch, a personal digital assistant (PDA), a cellular phone, a tablet computer, a slate computer, another diagnostic tool, or some combination of these.

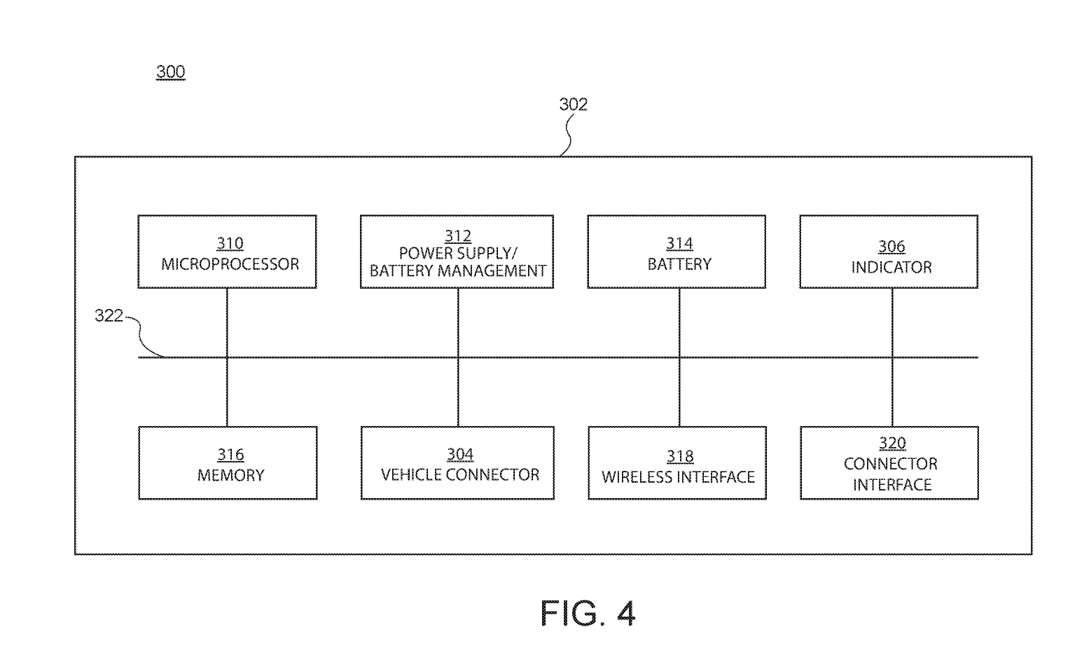

FIG. 4 illustrates exemplary components of the diagnostic tool 300 of FIG. 3. The components may include a microprocessor 310, a power supply/battery management 312, an optional internal battery 314, indicator 306, a memory 316, the vehicle connector 304, a wireless interface 318, and a connector interface 320. The components may communicate each other through a bus 322.

Microprocessor 310 may be a specialized diagnostic processor including having single, dual, quad, 8, 16, 32 core or any number of cores. The microprocessor 310 reads and processes data such as a program instruction stored in the memory 316 or vehicle data, such as diagnostic data from the vehicle ECU including mileage information. Microprocessor 310 may be embodied by a microcontroller, or may be a collection of electrical circuitry components built to interpret certain electrical signals and perform certain tasks in response to those signals. Additionally, the microprocessor 310 either internally therein or externally in communication therewith, associated RAM, ROM, EPROM, docks, decoders, memory containers, and/or interrupt controllers, etc. (all not shown) that are part of a processor circuit. In other embodiment, microprocessor may be or include an integrated circuit, a field programmable gate array (FPGA), a complex programmable logic device (CPLD), a programmable logic array (PLA), an application specific integrated circuit (ASIC), or a combination thereof.

The microprocessor 310 includes all necessary transceivers or alternatively individual transmitter and receiver to communicate in various communication protocols including, but are not limited to: SAE J1850 (VPM), SAE J1850 (PWM), J1708, J1587, LIN (local interconnect network), VAN (vehicle area network), ISO 9141-2, ISO 14230-4 (“Keyword 2000”), OBD I and II and the like. The present disclosure is not intended to be limited to any specific communications protocol, or even to electrical communications protocols. Other present and future protocols that the diagnostic tool may communicate in, such as fiber optic, ISO 15765-4, MS CAN, and HS CAN are also within the scope of the disclosure.

The microprocessor 310 can include an authentication processor that communicates with the wireless interface 318. The authentication processor can be one of the cores of the microprocessor 310 or a separate microprocessor. The authentication processor using the wireless interface 318 communicates with a remote authentication server in order to authenticate a software or hardware. The authentication may be based on serial number, brand name or unique identification, username, login information, vehicle identification number, fingerprint of the technician, password, cornea of the technician, DNA of the technician and other unique characteristics.

In an alternative embodiment and noted herein, the diagnostic tool 300 can include a display (not shown), such as a touch screen display, LED, OLED, VGA, and the like. The touch screen allows the technician to manipulate any of the screens, icons and the like discussed herein or show information to the technician. In this embodiment, the microprocessor 310 may communicate with the display on the diagnostic tool 300.

The diagnostic memory 316 can include, for example, volatile, non-volatile, solid state, flash, magnetic, optical, permanent, removable, writable, rewriteable, or read-only memory. If the diagnostic memory 316, is removable, examples may include a CD, DVD, or USB flash memory, which may be inserted into and removed from a CD and/or DVD reader/writer (not shown), or a USB, Fire-Wire, Serial, Parallel port (not shown).

The diagnostic memory 316 may contain software to run the diagnostic tool 300, communicate with the ECU or process vehicle data retrieved from the ECU or perform other functions described herein. The vehicle data may include diagnostic trouble codes (DTCs) that are set in the ECUs. Diagnostic memory 316 can store the necessary communication protocols used to communicate with a remote computing device such as a smart phone 400 or the ECU in the vehicle.

The power supply/battery management 312 can control power from various sources including an optional internal battery 314, USB connection, or the vehicle battery (not shown, as the diagnostic tool 300 can be powered by a battery in the vehicle when connected to the DLC), By way of example, the internal battery 314 may be any type of battery including a Lithium ion battery or a Lithium polymer type battery, Lithium Air, Lithium vanadium oxide, Nickel-Cadmium or nickel metal hydride battery. Internal battery 314 is chargeable at a rate of up to 1.5 A through connector interface 320, in accordance with “USB Battery Charging 1.2 Compliance plan” by USB Implementers Forum Inc., dated Oct. 12, 2011.

Indicator 306, as discussed above, can indicate to the technician the state of diagnostic tool 300. There can be more than one indicator and more than one color can be used to provide information regarding the diagnostic tool 300 to the technician. The vehicle connector 304 can be any type connector including an OBD I or II connector that couples to the data link connector in the vehicle.

The wireless interface 318 can include the appropriate transmitter, receiver, a transceiver or a combination thereof. The wireless interface 318 can be configured to communicate via, RF (radio frequency), satellites, cellular signals (analog or digital), Bluetooth®, Wi-Fi, Infrared, ZigBee, near field communication, infrared, Local Area Networks (LAN), WLAN (Wireless Local Area Network), other wireless communication configurations and standards or a combination thereof. Wireless interface 318 allows the diagnostic tool 300 to communicate with a remote device such as the smart phone 400. In other embodiment, the wireless interface 318 may include global positioning system receiver and transmitter in order to determine the location of the diagnostic tool 300 and indirectly the location of the vehicle to which the diagnostic tool is attached thereto.

The connector interface 320 may be any type of connector that allows a connection to another device and allows bidirectional or unidirectional communication and/or power to the diagnostic tool and another device. The connector interface 320 can be a serial port, parallel port, FireWire port, Ethernet port, a USB port, an infrared port, an RS 232 port, HDMI port or a port that is proprietary to the manufacturer of the diagnostic tool 300, or any other communications port.

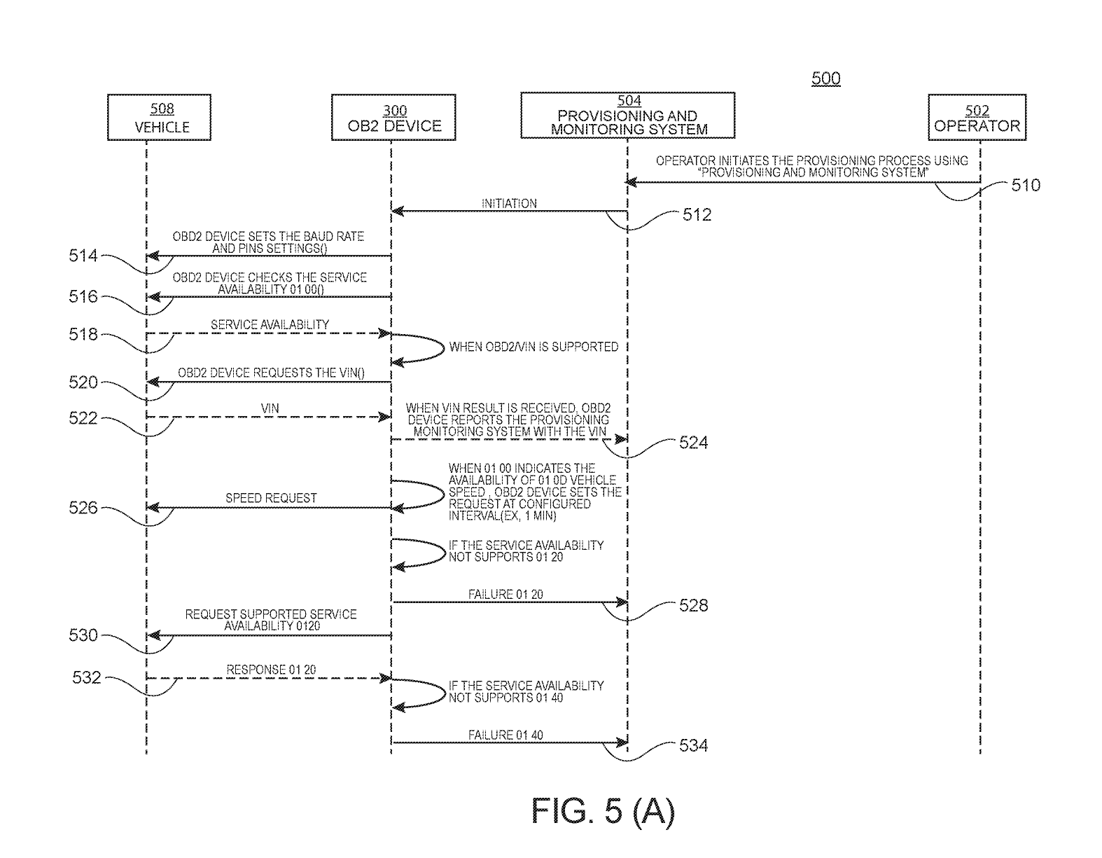

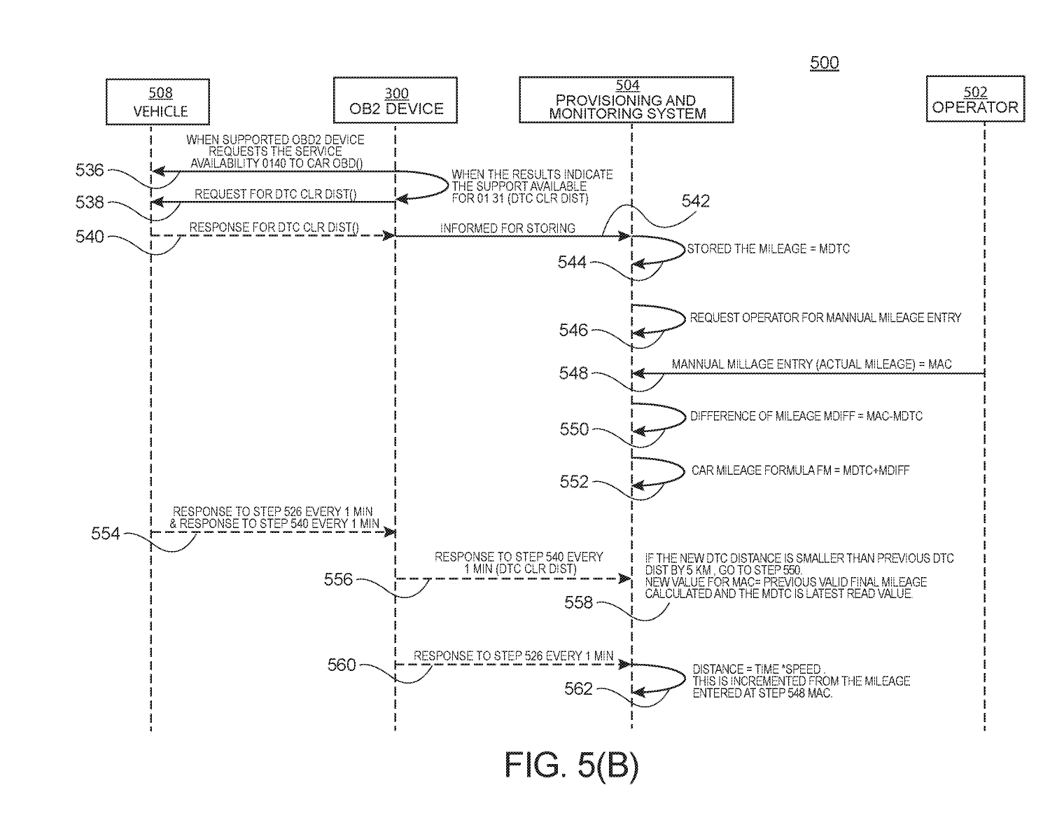

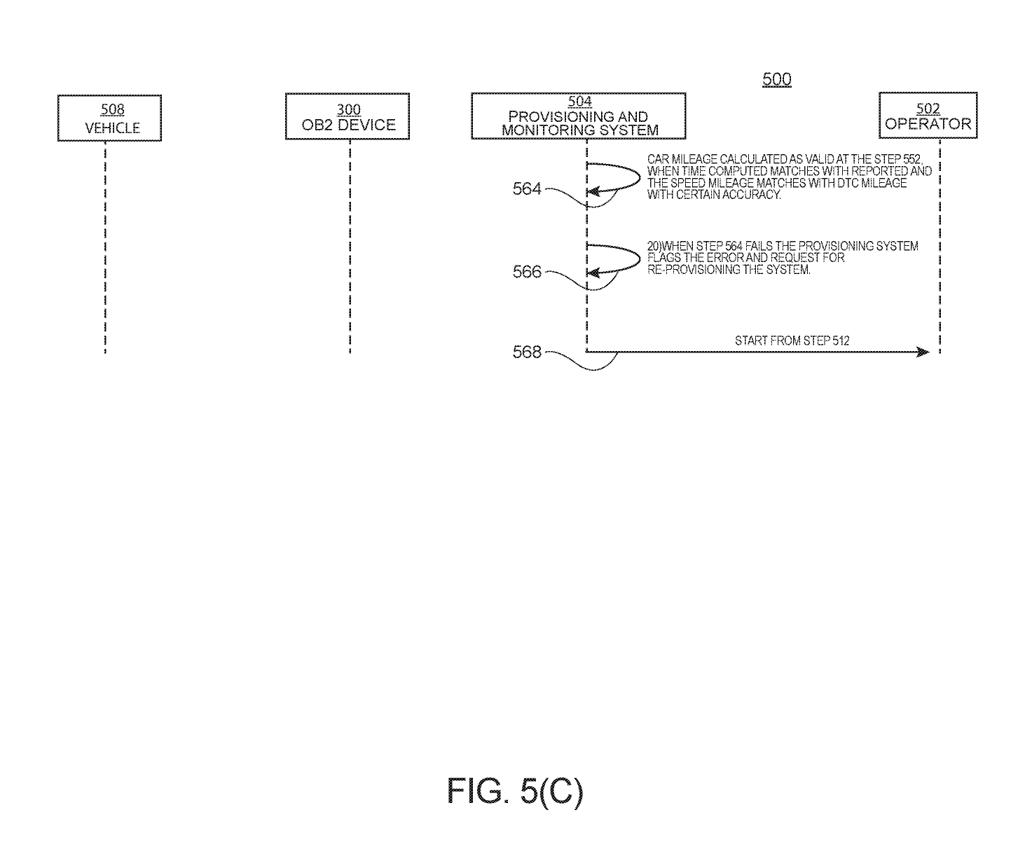

FIGS. 5A, 5B and 5C illustrate a method of determining mileage 500 of a vehicle 508 according to an embodiment of the disclosure. In general, the method of determining mileage 500 includes using an operator 502 such as the driver of the vehicle or a technician, the provisioning and monitoring system 504 (icon 128 on GUI 120 or icon 404) that is stored in diagnostic tool 100, or smartphone 400 and a vehicle 508. For the sake of brevity, the discussion for FIGS. 5A, 5B and 5C will be discussed using the embodiments of FIG. 3 but this is equally applicable to any diagnostic tool directly connected to the vehicle that includes the provisioning and monitoring system 504 either on the diagnostic tool or stored remotely from the diagnostic tool or smartphone 400. It should be noted that the steps in method 500 may be all conducted by the smartphone and that the diagnostic tool 100 can act simply as a pass through of the diagnostic information.

The operator 502 may start the method 500 at step 510 by actuating the provisioning and monitoring system 504 (in the form of an icon 404 of FIG. 3) on the smartphone 400 using his finger or stylus and the like. Once actuated, the provisioning and monitoring system 504 software initiates at step 512 the OBD II device/diagnostic tool 300 and instructions are carried out by the diagnostic processor of the smartphone 400 and the diagnostic tool 300. Diagnostic tool 300 sets the baud rate and appropriate pins settings at step 514 in order to retrieve information from the vehicle 508 through its electronic control units (ECUs) that are connected via bus system in the vehicle. At step 516, the diagnostic tool 300 verifies the service availability through onboard diagnostics parameter IDs (01 00) in the vehicle 508 and at step 518, the vehicle responds with information regarding service availability of the ECUs. That is, the ECU's respond by letting the diagnostic tool 300 know what diagnostic information are available in the ECU such as set DTC's time and mileage since DTCs were last cleared, readings of various sensors including speed sensors and the like.

At step 520, if vehicle 508 supports the vehicle identification number (VIN) request through OBD II, the diagnostic tool 300 can automatically request the VIN of the vehicle 508 under test. Requesting the VIN may be conducted as discussed in “System and Method for Automated Vehicle Selection and Automated Fixed Detection” of U.S. Pat. No. 9,213,332 assigned to Bosch Automotive Service Solutions LLC and is incorporated herein in its entirety. The reading of the VIN may be done using global OBD II mode 9 functionalities. Alternatively, the VIN may be entered manually by the operator 502 or scanned with the camera on the smartphone 400 using optical recognition software or barcode. If VIN is available through the OBD II, then a step 522, the vehicle 508 responds with the VIN to the diagnostic tool 300, which, at step 524, provides information to the provisioning and monitoring system 504.

When there is a response to 01 00 (at step 518) that indicates the availability of 01 OD vehicle speed, then the diagnostic tool 300, at step 526, sends the request for vehicle speed at a predetermined or configured interval such as one minute, five minutes, seven minutes and 10 minutes and the like. By knowing speed of the vehicle, the miles driven by the vehicle can be calculated as explained below. If the service ability for 01 20 (indicates that PIDS 21-40 information is available) is not supported as reported by the vehicle 508 in step 518, then at step 528 there would be a failure to receive information from the PIDS 21-40 and this is reported to the provisioning and monitoring system 504. If the vehicle reports service availability for 01 20, then at step 530, a request is sent to the vehicle 508 and at step 532, a response to the 01 20 request (information in PIDS 21-40) is sent back by the vehicle to the diagnostic tool 300.

Similarly, if the service availability for 01 40 (indicates that PIDS 41-60 information is available) is not supported as reported by the vehicle in step 518, then at step 534 there will be a failure to receive information from PIDS 41-60 and this is reported to the provisioning and monitoring system 504. If the vehicle reports service availability for 01 20 (step 518), which also includes support for information related to 01 31 DTC CLR DIST (distance traveled for the vehicle since DTCs cleared), then at steps 536, 538 the diagnostic tool 300 sends the request to the vehicle 508 for available information related to DTC CLR DIST (01 31) at a predetermined or configured interval such as one minute, five minutes, seven minutes and 10 minutes and the like. At step 540, the vehicle sends the available information related to DTC CLR DIST (distance in KM or miles). At step 542, the diagnostic tool 300 indicates and sends the DTC CLR DIST information to the provisioning and monitoring system 504 that the response has been received on the diagnostic tool 300. Step 544, the smartphone 400 automatically stores the mileage (miles or kilometer) since the DTC (MDTC) has cleared or in the alternative, the operator 502 to initiate the smartphone 400 to store the mileage information. In one example, the mileage may be 25,000 KM.

At step 546, on the display 402 of the smartphone 400, a request for the operator 502 to enter mileage displayed on the vehicle's odometer. At step 548, the vehicle's mileage is entered by the operator or MAC. In one example, the mileage may be 30,000 KM. The MAC should be higher than the MDTC number as presumably the vehicle would not have any set DTCs when it's new until the vehicle has been driven for a distance or time.

At step 550, smartphone 400 calculates the mileage difference (Mdiff, for example 5,000 KM) by subtracting MDTC (25,000 KM) from the MAC (30,000 KM). Then at step 552, the smartphone 400 calculates the final mileage formula (FM, for example 30,000 KM) by adding the MDTC (25,000 KM)+Mdiff (5,000 KM). The final mileage formula and the manually entered odometer mileage which should be within 5 KM or so, if not there is an error and the operator would be alerted to the error via the display of the smartphone 400 or via the fleet computing device discussed below. At this point, the process 500 may be stopped by the operator or automatically by the smartphone 400.

If no error, then at step 554, the speed of the vehicle (step 526) and the DTC CLR DIST (step 540) are provided by the vehicle 508 at the predetermined time such as every 1 minute to the diagnostic tool 300. At step 556, the DTC CLR DIST information is reported to the provisioning and monitoring system 505. At step 558, at this point, if the new DTC distance (step 556) is less than previous DTC (MDTC in step 544) distance by 5 KM then proceed to step 550 to recalculate Mdiff where the new value used for MAC is the previous valid FM calculated (step 552) and the MDTC is the latest send value (step 556). Simultaneously, before or after step 556, at step 560 the diagnostic tool 300 sends the vehicle response regarding the speed requests. At step 562, the distance is calculated by multiplying the time (1 min (interval)) by the speed (step 560). This is incremented to the mileage entered at step 548 for MAC to keep up with the odometer reading. At step 564, final mileage is calculated as valid at step 552 when the time computed matches with reported and the mileage based on speed (as calculated in step 562) matches the FM mileage (step 552) within a configurable tolerance level such as within 1%-20% including 3%, 5%, 10%, and 15%. It is expected that the DTC mileage should be more accurate than speed mileage. If the mileage is not within the configurable tolerance level of accuracy then the provisioning and monitoring system flags the error at step 566 and requests for the method 500 to be repeated and at step 568, the process proceeds back to step 512.

The process 500 results may be used to compare against reported mileage by the driver to determine if the mileage differences are beyond an acceptable range such as more than 5%. If it is beyond 5%, then the company may start a fraud investigation to determine if their error was a human error or due to fraudulent activities.

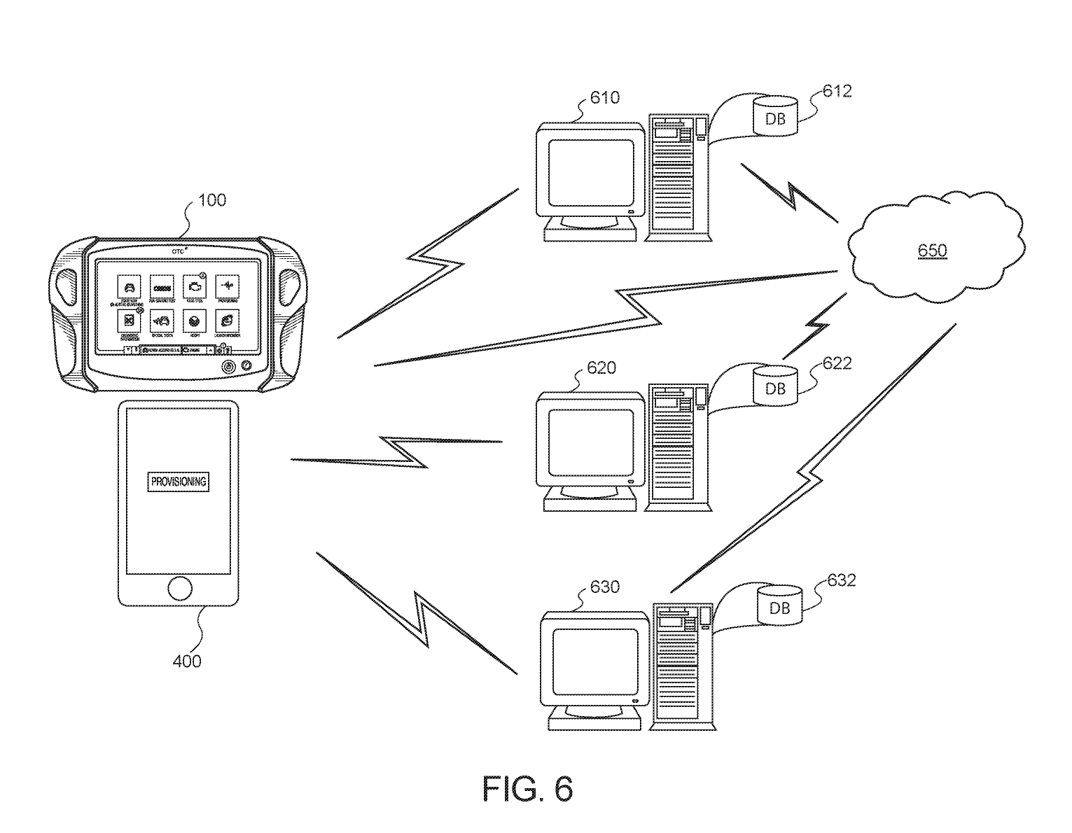

FIG. 6 illustrates the diagnostic tool 100 or smartphone 400 communicating with one or more remote computing devices 610, 620, 630 according to an embodiment of the disclosure. The diagnostic tool 100 or smartphone 400 may communicate via a wired or wireless connection (e.g. using wireless communication circuit 238) to the remote computing devices 610, 620, 630 directly or through the cloud/internet/distributed network 650. The remote computing devices 610, 620, 630 are not limited to the number of devices shown and may include any number of computing devices and includes databases 612, 622, 632, respectively. In one embodiment, the remote computing device 610 can be a fleet manager's server, the remote computing device 620 may be a maintenance/parts remote computing device and the remote computing device 630 may be a diagnostic data remote computing device. In another embodiment, the remote computing device may be local such as in the garage or in another building, another part of the city, another city, county, state or country. Alternatively, the processes 500 of FIGS. 5A, 5B and 5C may be controlled remotely by the fleet manager's computing device or any other computing device that is in communication with the smartphone that communicates with the diagnostic tool or directly with a diagnostic tool 100, 300 as described herein.

The fleet manager's computing device 610 may be for a trucking company that delivery goods or foods throughout the country or a vehicle rental company that rents vehicles such as cars, planes, ships, trains and the like. The fleet manager's computing device includes identifying information (such as VIN) for every vehicle it owns and the associated maintenance and leasing records and the like. The types of companies need to know the correct mileage on its vehicles for various purposes such as preventative maintenance, tax purposes, fraud prevention, leasing compliance and the like. The maintenance/parts remote computing device 320 may include maintenance and parts information including service dates and services completed, warranty, pricing, availability, diagrams, manuals, delivery options including mailing and local delivery, and other parts information. In one embodiment, once a certain mileage for the vehicle is reported such as at 30,000 KM and it coincides with the vehicle's maintenance schedule, then the maintenance/parts remote computing device 320 may alert the driver through his smartphone to schedule a maintenance time. A calendar reminder may be automatically added to the smartphone to remind the technician.

The diagnostic data remote computing device 630 may contain diagnostic software to diagnoses issues with the vehicle under test, information regarding DTCs, information regarding actual and potential fixes, diagrams, manuals, and the like.

As shown herein, a system and process are provided that allows for use in vehicles with OBD II to determine mileage in a vehicle. This allows the vehicle owners to obtain mileage from a vehicle at any time that the diagnostic tool or smartphone is connected to the vehicle. Additionally, the smartphone can be configured to communicate with a wireless diagnostic system that may be built into the vehicle such as OnStar by General Motors so that a diagnostic tool is not needed.

It should also be noted that the software implementations, such as the GUI of the disclosure as described herein can be stored on a tangible, non-transitory storage medium, such as: a magnetic medium such as a disk or tape; a magneto-optical or optical medium such as a compact disc or digital video disc; or a solid-state medium such as a memory card or other package that houses one or more read-only (non-volatile) memories, random access memories, or other re-writable (volatile) memories. Accordingly, the disclosure is considered to include a tangible storage medium or distribution medium, as listed herein and including art-recognized equivalents and successor media, in which the software implementations comprising code segments are stored. Additionally, although a diagnostic tool is described herein, the disclosure may be implemented on any computing device (having a processor and a memory) such as a personal computer, notebook, smart phone, a tablet and the like.

The many features and advantages of the disclosure are apparent from the detailed specification, and thus, it is intended by the appended claims to cover all such features and advantages of the disclosure, which fall within the true spirit, and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A non-transitory machine-readable storage medium comprising machine-readable instructions for causing a processor of a computing device to execute the method of:
receiving, by a processor of the computing device, a response from an electronic control unit (ECU) of a vehicle under test regarding available vehicle diagnostic information stored in the ECU;
receiving, by the processor of the computing device, and storing on a memory of the computing device, a first speed of the vehicle at a predetermined time interval;
receiving, by the processor of the computing device, and storing on the memory of the computing device, a first vehicle's driven mileage distance since a diagnostic trouble code (DTC) was cleared;
receiving, by the processor of the computing device, a mileage on an odometer of the vehicle;
determining, with the processor of the computing device, a difference mileage between the received odometer mileage and the first vehicle's driven mileage distance since the DTC was cleared;
determining by the processor of the computing device a final mileage of the vehicle by adding the first vehicle's driven distance mileage since the DTC was cleared and the received odometer mileage; and
determining by the processor of the computing device that there is an error if the difference between the determined final mileage and the received odometer mileage is more than 5 KM.

2. The non-transitory machine-readable storage medium of claim 1 further comprising:
alerting, via the processor, a user of the error via a display of the computing device.

3. The non-transitory machine-readable storage medium of claim 1 further comprising:
continuously receiving, via the processor, a second speed of the vehicle and a second vehicle's driven distance mileage since the DTC was cleared at the predetermined level;
if the second vehicle's driven distance mileage since the DTC was cleared is less than the first vehicle's driven distance mileage since the DTC was cleared by 5 KM then repeat the determining difference of mileage by replacing the odometer mileage with the determined final mileage and replacing the first vehicle's driven distance mileage since the DTC was cleared with the second vehicle's driven distance mileage since the DTC was cleared;
calculating, via the processor, a distance mileage travelled by the vehicle by multiplying the predetermined time interval by the second speed of the vehicle; and
incrementing, via the processor, the calculated distance travelled to the received odometer mileage.

4. The non-transitory machine-readable storage medium of claim 3 further comprising validating, via the processor, the determined final mileage if the incremented calculated distance travelled to the received odometer mileage is within 20% of the determined final mileage.

5. The non-transitory machine-readable storage medium of claim 4 further comprising:
if the determined final mileage is not validated then sending an error alert to a display of the computing device.

6. The non-transitory machine-readable storage medium of claim 1 further comprising receiving, by the processor of the computing device, a vehicle identification number from the vehicle.

7. The non-transitory machine-readable storage medium of claim 1 further comprising displaying on a display of the computing device, an alert that certain vehicle diagnostic information is not available.

8. A vehicle diagnostic tool with mileage retrieval, comprising:
a processor configured to execute computing instructions;
a connector interface configured to connect with a connector in a vehicle and retrieve vehicle diagnostic data from the vehicle, wherein vehicle diagnostic data include a first speed of a vehicle at a predetermined time interval and a first vehicle's driven mileage distance since a diagnostic trouble code (DTC) was cleared;
a display in communication with the processor configured to display vehicle diagnostic data;
a wireless communication interface in communication with the processor and configured to communicate with a remote device having a database; and
a memory in communication with the processor, the memory containing instructions, that when executed by the processor causes the processor to:
receive a response from an electronic control unit (ECU) of a vehicle under test regarding available vehicle diagnostic information stored in the ECU;
receive and store on the memory of the vehicle diagnostic tool, the first speed of the vehicle at a predetermined time interval;
receive and store on the memory of the vehicle diagnostic tool, the first vehicle's driven mileage distance since a diagnostic trouble code (DTC) was cleared;
receive a mileage on an odometer of the vehicle entered by a user;
determine, a difference mileage between the received odometer mileage and the first vehicle's driven mileage distance since the DTC was cleared;
determine a final mileage of the vehicle by adding the first vehicle's driven distance mileage since the DTC was cleared and the received odometer mileage; and
determine that there is an error if the difference between the determined final mileage and the received odometer mileage is more than 5 KM.

9. The diagnostic tool of claim 8 further comprising alerting, via the processor the user of the error via a display of the diagnostic tool.

10. The diagnostic tool of claim 8 further comprising:
continuously receiving, via the processor, a second speed of the vehicle and a second vehicle's driven distance mileage since the DTC was cleared at the predetermined level;
if the second vehicle's driven distance mileage since the DTC was cleared is less than the first vehicle's driven distance mileage since the DTC was cleared by 5 KM then repeat the determining difference of mileage by replacing the odometer mileage with the determined final mileage and replacing the first vehicle's driven distance mileage since the DTC was cleared with the second vehicle's driven distance mileage since the DTC was cleared;
calculating, via the processor, a distance mileage travelled by the vehicle by multiplying the predetermined time interval by the second speed of the vehicle; and
incrementing, via the processor, the calculated distance travelled to the received odometer mileage.

11. The diagnostic tool of claim 10 further comprising validating, via the processor, the determined final mileage if the incremented calculated distance travelled to the received odometer mileage is within 20% of the determined final mileage.

12. The diagnostic tool of claim 11, wherein if the determined final mileage is not validated then sending an error alert to a display of the diagnostic tool.

13. The diagnostic tool of claim 8 further comprising receiving, by the processor of the diagnostic tool, a vehicle identification number from the vehicle.

14. The diagnostic tool of claim 8 further comprising displaying on a display of the diagnostic tool, an alert that certain vehicle diagnostic information is not available.

15. The diagnostic tool of claim 11, wherein if the determined final mileage is not validated then sending an error alert to a display of the remote computing device.

16. A vehicle diagnostic tool with mileage retrieval, comprising:
means for processing configured to execute computing instructions;
means for interfacing configured to connect with a connector in a vehicle and retrieve vehicle diagnostic data from the vehicle, wherein vehicle diagnostic data include a first speed of a vehicle at a predetermined time interval and a first vehicle's driven mileage distance since a diagnostic trouble code (DTC) was cleared;
means for displaying in communication with the means for processing configured to display vehicle diagnostic data;
means for wireless communicating in communication with the means for processing and configured to communicate with a remote device having a database; and
means for storing in communication with the means for processing, the means for storing containing instructions, that when executed by the means for processing causes the means for processing to:
receive a response from an electronic control unit (ECU) of a vehicle under test regarding available vehicle diagnostic information stored in the ECU;
receive and store on the means for storing of the vehicle diagnostic tool, the first speed of the vehicle at a predetermined time interval;
receive and store on the means for storing of the vehicle diagnostic tool, the first vehicle's driven mileage distance since a diagnostic trouble code (DTC) was cleared;
receive a mileage on an odometer of the vehicle entered by a user;
determine, a difference mileage between the received odometer mileage and the first vehicle's driven mileage distance since the DTC was cleared;
determine a final mileage of the vehicle by adding the first vehicle's driven distance mileage since the DTC was cleared and the received odometer mileage; and
determine that there is no error if the difference between the determined final mileage and the received odometer mileage is less than 5 KM.

17. The diagnostic tool of claim 16 further comprising determine, with the means for processing, that there is an error if the difference between the determined final mileage and the received odometer mileage is more than 5 KM.

18. The diagnostic tool of claim 17 further comprising alerting, via the means for processing, the user of the error via the means for displaying of the remote computing device.

19. The diagnostic tool of claim 17 further comprising alerting, via the means for processing, the user of the error via the means for displaying of the diagnostic tool.

20. The diagnostic tool of claim 16 further comprising:
continuously receiving, via the means for processing, a second speed of the vehicle and a second vehicle's driven distance mileage since the DTC was cleared at the predetermined level;
if the second vehicle's driven distance mileage since the DTC was cleared is less than the first vehicle's driven distance mileage since the DTC was cleared by 5 KM then repeat the determining difference of mileage by replacing the odometer mileage with the determined final mileage and replacing the first vehicle's driven distance mileage since the DTC was cleared with the second vehicle's driven distance mileage since the DTC was cleared;
calculating, via means for processing, a distance mileage travelled by the vehicle by multiplying the predetermined time interval by the second speed of the vehicle; and
incrementing, means for processing, the calculated distance travelled to the received odometer mileage.
